(19) United States
(12) Patent Application Publication
(10) Pub. No.: US 2019/0271867 A1
(43) Pub. Date: Sep. 5, 2019

(54) METHOD OF PRODUCING LIQUID CRYSTAL DISPLAY DEVICE AND ALIGNMENT FILM MATERIAL

(71) Applicant: SHARP KABUSHIKI KAISHA, Sakai City, Osaka (JP)

(72) Inventors: HIROSHI TSUCHIYA, Sakai City (JP); MASANOBU MIZUSAKI, Sakai City (JP)

(21) Appl. No.: 16/322,881

(22) PCT Filed: Aug. 1, 2017
(86) PCT No.: PCT/JP2017/027799

§ 371 Date: Feb. 1, 2019

(30) Foreign Application Priority Data
Aug. 8, 2016 (JP) 2016-155803

(51) Int. Cl. G02F 1/1337; C09K 19/56; C08F 2/48

(52) U.S. Cl. CPC G02F 1/1337; G02F 2001/133726; C08F 2/48; C09K 19/56

(57) ABSTRACT

A method of producing the liquid crystal display device of the present invention is a method of producing a liquid crystal display device including a pair of substrates and a liquid crystal layer disposed between the substrates, the method including: forming the liquid crystal layer by sealing a liquid crystal material containing liquid crystal molecules including an alkenyl group between the substrates facing each other with a sealant in between; and performing an alignment treatment on an alignment film containing a polymer including a polymerizable group in a side chain and being disposed on a liquid crystal layer side surface of at least one of the substrates by irradiating the alignment film with ultraviolet rays and thereby polymerizing the polymerizable group.

### TECHNICAL FIELD

The present invention relates to methods of producing a liquid crystal display device and alignment film materials. The present invention more specifically relates to a method of producing a liquid crystal display device suitable for head mounted displays (HMDs) and an alignment film material used in the method of producing a liquid crystal display device.

### BACKGROUND ART

Liquid crystal display devices have been widely used in applications including televisions, electronic book readers, digital photo frames, industrial appliances, personal computers (PCs), tablet PCs, smartphones, and HMDs. In these applications, liquid crystal display devices are required to exhibit various performances. This has led to development of various liquid crystal display modes.

Examples of the liquid crystal display modes include alignment modes which align liquid crystal molecules in a direction substantially parallel to the main surface of a substrate in a no-voltage applied state (hereinafter, such modes are also referred to as horizontal alignment modes), such as the in-plane switching (IPS) mode and the fringe field switching (FFS) mode. The examples also include alignment modes which align liquid crystal molecules in a direction substantially perpendicular to the main surface of a substrate in a no-voltage applied state (hereinafter, such modes are also referred to as vertical alignment modes), such as the vertical alignment (VA) mode. For achievement of such alignment control of liquid crystal molecules, techniques utilizing an alignment film have been suggested.

The techniques utilizing an alignment film include a technique which dissolves monomers (polymerizable monomers) in a liquid crystal material and irradiates the monomers with ultraviolet rays (ultraviolet light) after formation of a liquid crystal panel to polymerize the monomers, thereby forming a polymer layer (hereinafter, a liquid crystal display device obtained by such a polymer sustained alignment (PSA) technique is also referred to as a PSA-LCD). For example, PSA-LCDs are a possible choice as liquid crystal display devices for HMD applications, which are desired to exhibit high-speed video display performance (rapid response performance) and a wide viewing angle. Such PSA-LCDs, which are desired to achieve rapid response, require an alkenyl group-containing liquid crystal compound. The alkenyl group-containing liquid crystal compound, however, hinders the polymerization reaction. Hence, the ultraviolet irradiation dose in the PSA technique, including application of ultraviolet rays as described above, needs to be increased such that monomers remaining in the liquid crystal layer are eliminated. However, irradiating the alkenyl group-containing liquid crystal compound, which is actually vulnerable to ultraviolet rays, with a large amount of ultraviolet rays degrades the alkenyl group-containing liquid crystal compound. This decreases the voltage holding ratio (VHR) to increase the residual DC voltage (rDC, direct current voltage component generated in the liquid crystal cell), causing image sticking. Meanwhile, reduction in ultraviolet irradiation dose causes monomers to remain, though slightly, in the liquid crystal layer. The residual monomers in the liquid crystal layer are gradually polymerized while the liquid crystal display device is used for a long period of time, which also causes image sticking.

In HMD applications, a low resolution causes the partition lines between pixels to be visible in use of the liquid crystal display device, and thus a high-resolution display device preventing such a phenomenon has been desired (the pixel size is preferably, for example, 32 μm or less×11 μm or less, more preferably 25 μm or less×8.5 μm or less). As the resolution increases, however, the aperture ratio decreases and thus the unirradiated area increases. This increases the concentration of monomers unpolymerized and remaining in the liquid crystal layer even when irradiated with ultraviolet rays for polymerization, causing image sticking due to residual monomers and a VHR decrease.

An example of disclosed inventions related to PSA-LCDs is a liquid crystal alignment agent containing at least one polymer selected from a polyimide precursor obtained by reacting a diamine component containing a diamine compound represented by a specific formula and a tetracarboxylic dianhydride component, and a polyimide obtained by imidizing the polyimide precursor (for example, Patent Literature 1).

An example of disclosed methods for producing a liquid crystal display device is a method of manufacturing a liquid crystal display device including an array of plural pixels, each of the plural pixels including a first substrate and a second substrate, a first electrode formed on an opposing surface of the first substrate, which surface is positioned opposite to the second substrate, a first alignment restricting portion provided in the first electrode, a first alignment film covering the first electrode, the first alignment restricting portion, and the opposing surface of the first substrate, a second electrode formed on an opposing surface of the second substrate, which surface is positioned opposite to the first substrate, a second alignment restricting portion provided in the second electrode, a second alignment film covering the second electrode, the second alignment restricting portion, and the opposing surface of the second substrate, and a liquid crystal layer formed between the first alignment film and the second alignment film and containing liquid crystal molecules having negative dielectric anisotropy, in each pixel, major axes of a group of liquid crystal molecules in the liquid crystal layer being positioned substantially in the same imaginary plane in a central region of an overlapped region where a projected image of a region surrounded by edges of the first electrode and two first alignment restricting portions overlaps with a projected image of a region surrounded by edges of the second electrode and two second alignment restricting portions, the method comprising: forming, on the first substrate, the first alignment film made of a high-molecular compound having a cross-linkable functional group or a polymerizable functional group in at least one side chain thereof; forming the second alignment film on the second substrate; arranging the first substrate and the second substrate such that the first alignment film and the second alignment film are positioned to face each other, and forming the liquid crystal layer, which contains the liquid crystal molecules having negative dielectric anisotropy, in a sealed-off state between the first alignment film and the second alignment film; and after forming the liquid crystal layer in the sealed-off state, cross-linking the high-molecular compound such that a pre-tilt is given to the liquid crystal molecule (for example, Patent Literature 2).

### CITATION LIST

### Patent Literature

Patent Literature 1: WO 2013/099804
Patent Literature 2: JP 2012-32601 A

### SUMMARY OF INVENTION

### Technical Problem

The invention disclosed in Patent Literature 1 is described to enable production of a PSA-LCD by introducing a polymerizable group into a side chain of a polyamic acid polymer constituting an alignment film.

Patent Literature 2 discloses, as a technique to increase the response speed in the VA mode, a method of photocrosslinking a side chain of a polymer compound constituting an alignment film.

In response to the above issues, an object of the present invention is to provide a liquid crystal display device capable of sufficiently preventing image sticking on the display screen and exhibiting rapid response performance suitable for applications such as HMDs, and an alignment film material used in the method of producing the liquid crystal display device.

### Solution to Problem

The present inventors focused on introduction of a polymerizable group (e.g., a vinyl group such as an acrylic group or a methacrylic group, and/or a cinnamate group) for alignment fixation by the PSA technique into the liquid crystal layer in a liquid crystal display device suitable for applications such as HMDs in the state where the polymerizable group is chemically bonded to a site such as a side chain of a polymer constituting the alignment film, not in the state where the polymerizable group is bonded to a monomer. The polymerizable group bonded to a site such as a side chain of a polymer as described above is polymerized by application of ultraviolet rays as in the conventional PSA technique.

In other words, one aspect of the present invention may be method of producing a liquid crystal display device including a pair of substrates and a liquid crystal layer disposed between the substrates, the method including: forming the liquid crystal layer by sealing a liquid crystal material containing liquid crystal molecules including an alkenyl group between the substrates facing each other with a sealant in between; and performing an alignment treatment on an alignment film containing a polymer including a polymerizable group in a side chain and being disposed on a liquid crystal layer side surface of at least one of the substrates by irradiating the alignment film with ultraviolet rays and thereby polymerizing the polymerizable group. The forming the liquid crystal layer may include, for example, disposing (applying in a predetermined pattern) a sealant on one of the substrates along the periphery of the substrate such that the liquid crystal material can be sealed between the substrates, dropping the liquid crystal material inside the region surrounded by the applied sealant, bonding the substrate to the other substrate, curing the sealant with, for example, ultraviolet rays, and thereby sealing the liquid crystal material.

Another aspect of the present invention may be an alignment film material containing: a polymer material whose main chain is derived from a polyamic acid or a polysiloxane and whose side chain includes a vinyl group and/or a cinnamate group; and a radical polymerization initiator.

Patent Literature 1 and Patent Literature 2 described above fail to disclose an alkenyl group-containing liquid crystal compound.

The alignment treatment in the method of producing a liquid crystal display device according to the present invention may be performed to align the liquid crystal molecules in a direction perpendicular to the alignment film. Aligning the liquid crystal molecules in the direction perpendicular to the alignment film may be any process that aligns the liquid crystal molecules in a direction substantially perpendicular to the alignment film.

The performing an alignment treatment in the method of producing a liquid crystal display device according to the present invention may include irradiating a radical polymerization initiator in the alignment film with ultraviolet rays to generate a radical and thereby polymerizing the polymerizable group in the side chain of the polymer. The radical polymerization initiator is, in other words, a photopolymerization initiator. The main chain of the polymer constituting the alignment film preferably has a polyamic acid structure, a polyimide structure, or a polysiloxane structure.

The performing the alignment treatment in the method of producing a liquid crystal display device according to the present invention may include irradiating a radical polymerization initiator in the sealant with ultraviolet rays to generate a radical and thereby polymerizing the polymerizable group in the side chain of the polymer.

The performing the alignment treatment in the method of producing a liquid crystal display device according to the present invention may include irradiating the radical polymerization initiator with ultraviolet rays to cleave the radical polymerization initiator and generate a radical.

The performing the alignment treatment in the method of producing a liquid crystal display device may include irradiating the radical polymerization initiator with ultraviolet rays to abstract a hydrogen atom from the radical polymerization initiator and generate a radical.

The polymerizable group in the method of producing a liquid crystal display device according to the present invention may contain a vinyl group and/or a cinnamate group.

The forming the liquid crystal layer in the method of producing a liquid crystal display device according to the present invention may include sealing a liquid crystal material containing liquid crystal molecules each including one alkenyl group between the substrates.

The radical polymerization initiator in the method of producing a liquid crystal display device according to the present invention may generate a radical in a cleavage reaction or a hydrogen atom abstraction reaction. The cleavage reaction or hydrogen atom abstraction reaction of the radical polymerization initiator may be caused by the application of ultraviolet rays.

### Advantageous Effects of Invention

The present invention can sufficiently prevent image sticking in a liquid crystal display device exhibiting rapid response performance suitable for applications such as HMDs.

### BRIEF DESCRIPTION OF DRAWINGS

FIG. 1 is a schematic cross-sectional view of a liquid crystal display device of the present embodiment.

FIG. 2 is another schematic cross-sectional view of the liquid crystal display device of the present embodiment.

FIG. 3 is a schematic top view of a liquid crystal display device for HMDs.

FIG. 4 is a schematic cross-sectional view of a conventional liquid crystal display device.

### DESCRIPTION OF EMBODIMENTS

The present invention is described in more detail below based on embodiments with reference to the drawings. The embodiments, however, are not intended to limit the scope of the present invention. The configurations of the embodiments may appropriately be combined or modified within the spirit of the present invention.

The mode as used herein which aligns liquid crystal molecules in a direction substantially parallel to a main surface of a substrate in a no-voltage applied state is also referred to as a horizontal alignment mode. The expression “substantially parallel” means that, for example, the pre-tilt angle of the liquid crystal molecules is 0° or greater and 5° or smaller relative to the main surface of the substrate. The mode which aligns liquid crystal molecules in a direction substantially perpendicular to the main surface of the substrate in a no-voltage applied state is also referred to as a vertical alignment mode. The expression “substantially perpendicular” means that, for example, the pre-tilt angle of the liquid crystal molecules is 85° or greater and 90° or smaller relative to the main surface of the substrate. A room temperature means a temperature of 15° C. or higher and 40° C. or lower, unless otherwise mentioned.

A chemical bond as used herein usually means a covalent bond. Ultraviolet rays are electromagnetic waves having a wavelength of 1 to 400 nm and preferably include ultraviolet rays having a wavelength of 300 to 400 nm.

The present invention is applicable to both horizontal alignment mode liquid crystal display devices and vertical alignment mode liquid crystal display devices, but is preferably applied to vertical alignment mode liquid crystal display devices.

### (Example of Main Chain of Polymer (Polyamic Acid, Polyimide) Having Polymerizable Group and Constituting Alignment Film)

A photo-alignment film containing a polymer whose main chain has a polyamic acid structure is also referred to as a polyamic acid-based photo-alignment film.

Preferred examples of the polymer whose main chain has a polyamic acid structure include those having a polyamic acid structure represented by the following formula (1).

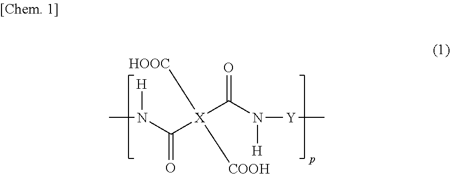

In the formula (1), p shows the degree of polymerization and is an integer of 1 or greater, preferably 10 or greater.

In the formula (1), at least one of X or Y preferably contains a photo-functional group. When X contains no photo-functional group, X may be a tetravalent group represented by any one of the following formulas (2-1) to (2-12). These groups can be used both for horizontal alignment films and vertical alignment films.

In the formulas (2-1) to (2-12), the symbol “*” shows the site binding to another atom. The same applies to the other formulas mentioned later.

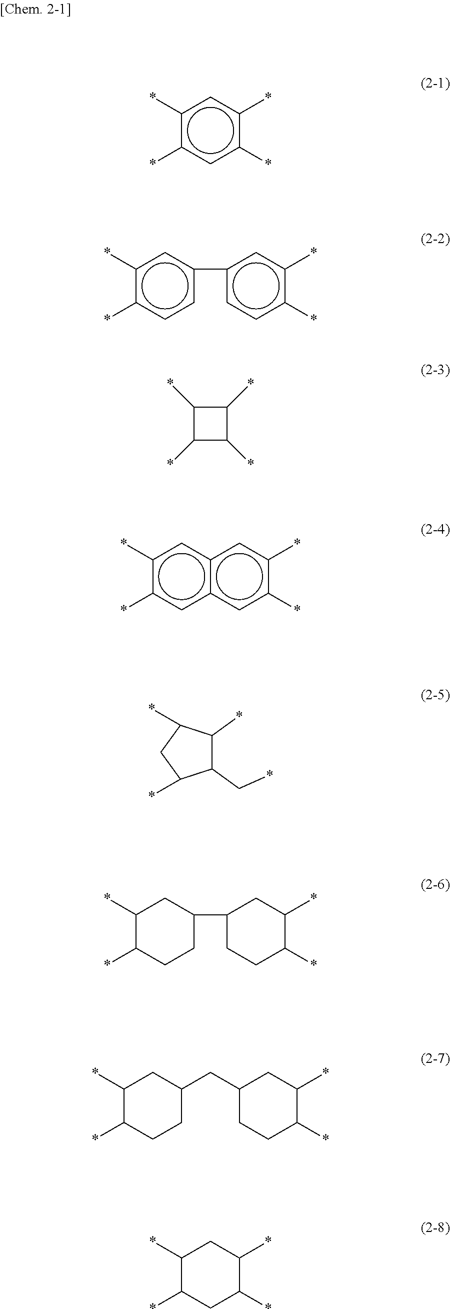

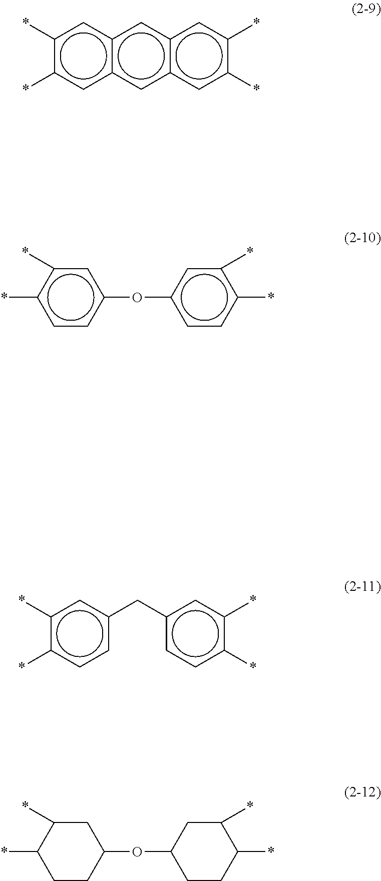

In the formula (1), when X contains a photo-functional group, X is preferably, for example, a tetravalent group represented by any one of the following formulas (2-13) to (2-16). These groups can be used for horizontal photo-alignment films configured to align liquid crystal molecules in a direction substantially parallel to their surfaces and vertical photo-alignment films configured to align liquid crystal molecules in a direction substantially perpendicular to their surfaces.

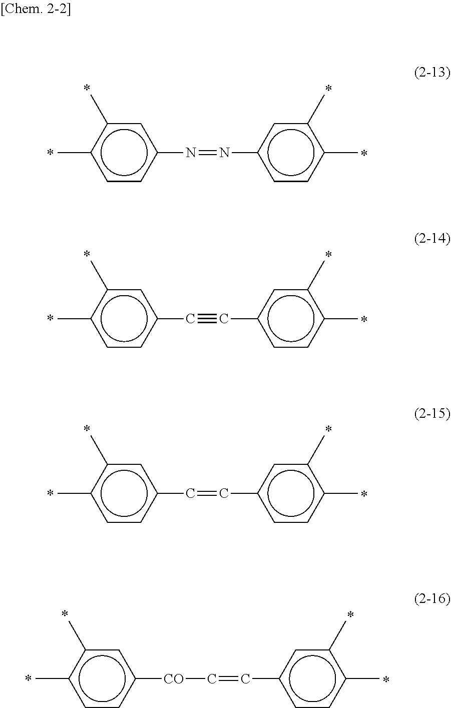

In the formula (1), when Y contains a photo-functional group, Y is preferably, for example, a divalent group represented by the following formula (3-1). This group can be used for both horizontal photo-alignment films and vertical photo-alignment films.

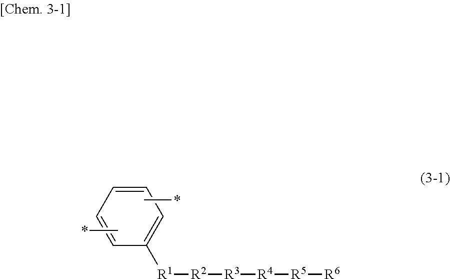

In the formula, R¹ represents —CH₂—, —O—, —CONH—, —NHCO—, —COO—, —OCO—, —NH—, or —CO—; R² represents a C1-C30 alkylene group, a divalent carbon ring, or a heterocycle, wherein at least one hydrogen atom of the alkylene group, the divalent carbon ring, or the heterocycle may be replaced by a fluorine atom or an organic group, and —CH₂— in R² may be replaced by any of the following groups unless any of these groups are adjacent to each other: —O—, —NHCO—, —CONH—, —COO—, —OCO—, —NH—, —NHCONH—, and —CO—; R; represents —CH₂—, —O—, —CONH—, —NHCO—, —COO—, —OCO—, —NH—, —CO—, or a single bond; R⁴ represents a group which causes photodimerization; R⁵ represents a single bond, a C1-C30 alkylene group, a divalent carbon ring, or a heterocycle, wherein at least one hydrogen atom in the alkylene group, the divalent carbon ring, or the heterocycle may be replaced by a fluorine atom or an organic group, and —CH₂— in R⁵ may be replaced by any of the following groups unless any of these groups are adjacent to each other: —O—, —NHCO—, —CONH—, —COO—, —OCO—, —NH—, —NHCONH—, and —CO—; and R⁶ represents a photopolymerizable group.

In the formula (1), Y may be a divalent group represented by any one of the following formulas (3-2) to (3-18). These groups can be used for both horizontal alignment films and vertical alignment films.

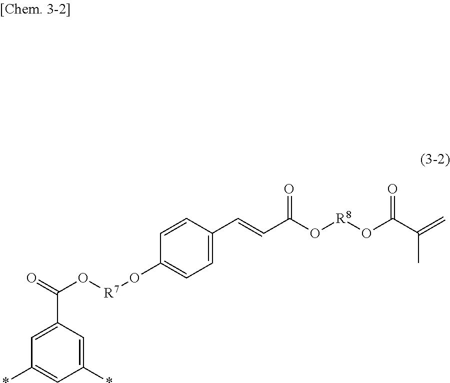

In the formula, R⁷ represents a C2-C6 alkylene group, and R⁸ represents a C2-C4 alkylene group.

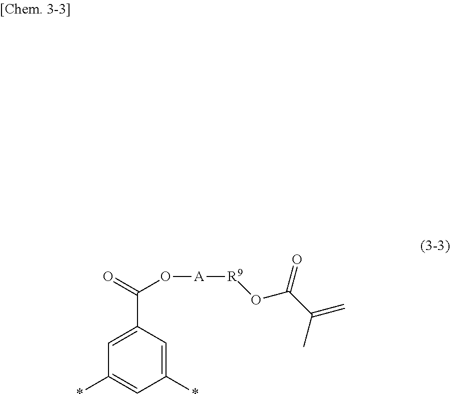

In the formula, A represents a divalent linking group, preferably one represented by the following formula (A-1) or (A-2), and R⁹ represents a C2-C6 alkylene group.

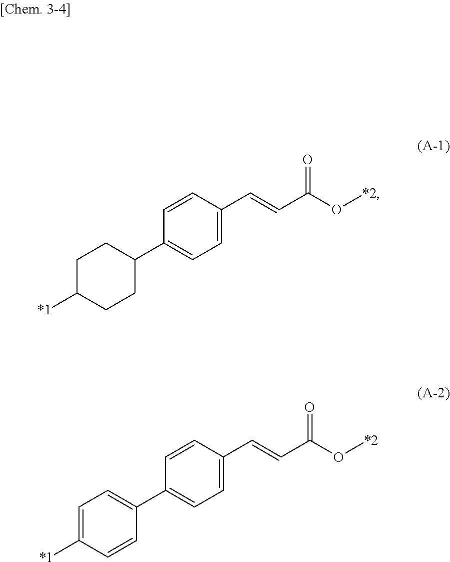

In the formula, *1 represents the site binding to an oxygen atom, and *2 represents the site binding to a carbon atom of R⁹.

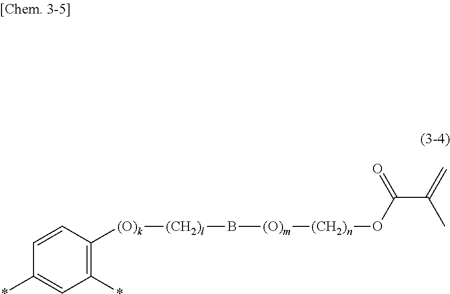

In the formula, B represents a divalent linking group, preferably one represented by any one of the following formulas (B-1) to (B-5); k is 0 or 1; 1 is an integer of 1 to 6; m is 0 or 1; n is 0 when m is 0; and n is an integer of 1 to 6 when m is 1.

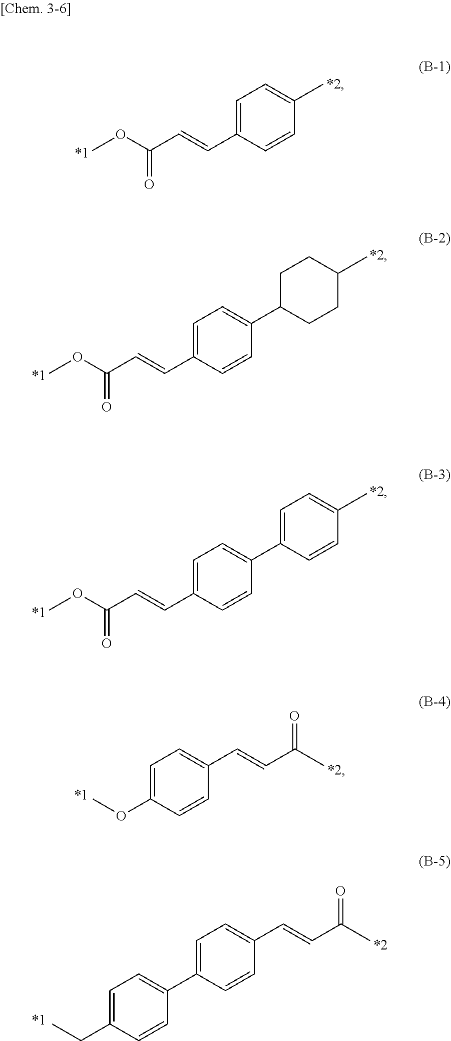

In the formulas, *1 is the site binding to the carbon atom of CH₂, and *2 represents the site binding to an oxygen atom.

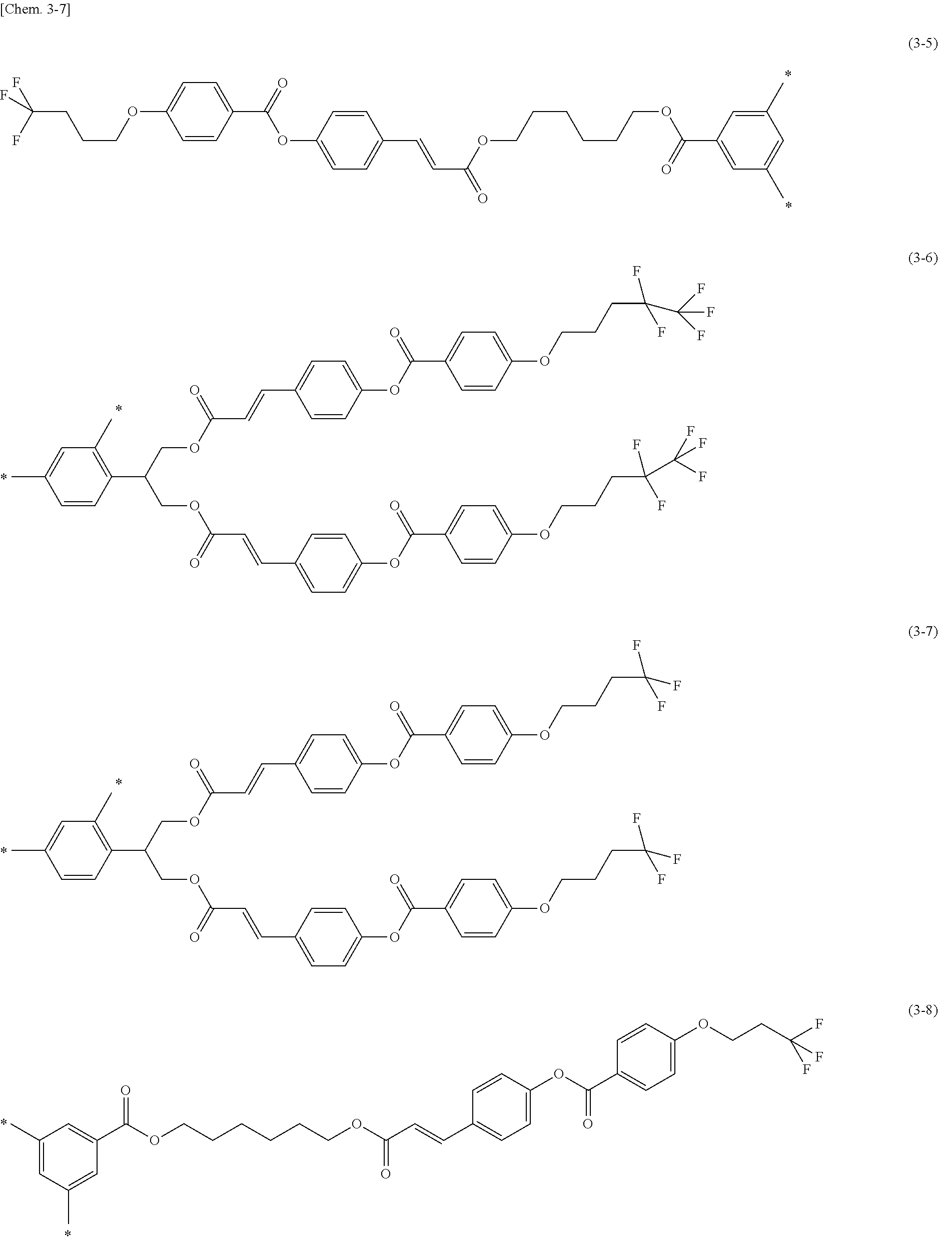

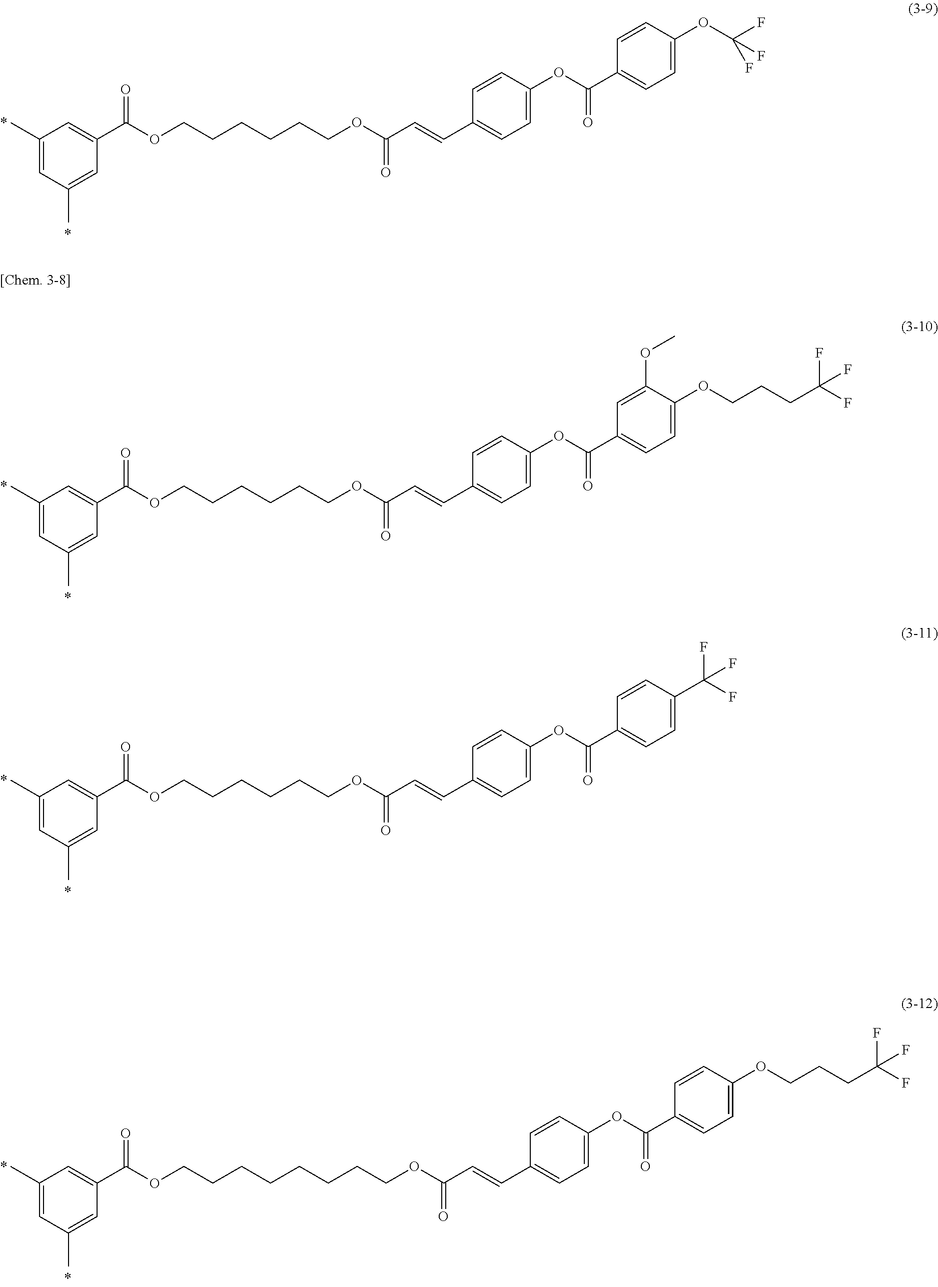 [SMILES: Cc1cc(C)cc(C(=O)OCCCCCCOC(=O)/C=C/c2ccc(OC(=O)c3ccc(OC(F)(F)F)cc3)cc2)c1 ; COc1cc(C(=O)Oc2ccc(/C=C/C(=O)OCCCCCCOC(=O)c3cc(C)cc(C)c3)cc2)ccc1OCCCC(F)(F)F ; Cc1cc(C)cc(C(=O)OCCCCCCOC(=O)/C=C/c2ccc(OC(=O)c3ccc(C(F)(F)F)cc3)cc2)c1 ; Cc1cc(C)cc(C(=O)OCCCCCCCCOC(=O)/C=C/c2ccc(OC(=O)c3ccc(OCCCC(F)(F)F)cc3)cc2)c1]

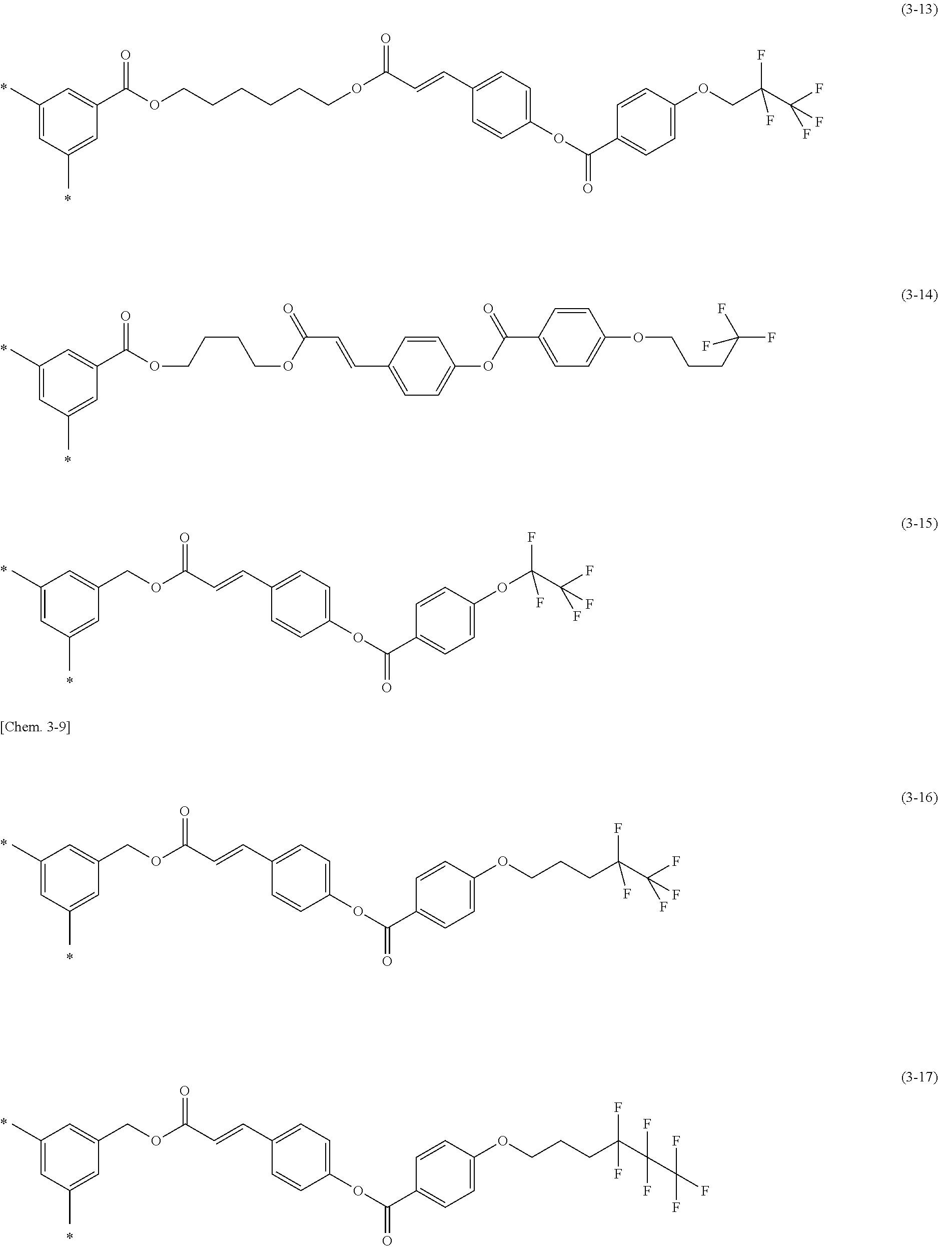 [SMILES: Cc1cc(C)cc(C(=O)OCCCCCCOC(=O)/C=C/c2ccc(OC(=O)c3ccc(OCC(F)(F)C(F)(F)F)cc3)cc2)c1 ; Cc1cc(C)cc(C(=O)OCCCCOC(=O)/C=C/c2ccc(OC(=O)c3ccc(OCCCC(F)(F)F)cc3)cc2)c1 ; Cc1cc(C)cc(COC(=O)/C=C/c2ccc(OC(=O)c3ccc(OC(F)(F)C(F)(F)F)cc3)cc2)c1 ; Cc1cc(C)cc(COC(=O)/C=C/c2ccc(OC(=O)c3ccc(OCCCC(F)(F)C(F)(F)F)cc3)cc2)c1 ; Cc1cc(C)cc(COC(=O)/C=C/c2ccc(OC(=O)c3ccc(OCCCC(F)(F)C(F)(F)C(F)(F)F)cc3)cc2)c1]

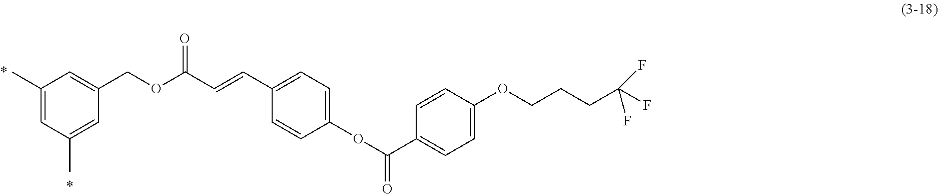 [SMILES: Cc1cc(C)cc(COC(=O)/C=C/c2ccc(OC(=O)c3ccc(OCCCC(F)(F)F)cc3)cc2)c1]

For achievement of a high contrast ratio of the liquid crystal display device, the alignment film used is preferably a photo-alignment film. The alignment film is considered as a photo-alignment film when at least one of the above X or Y is a photo-functional group.

(Example of main chain of polymer (polysiloxane) having polymerizable group and constituting alignment film)

Preferred examples of the polymer whose main chain has a polysiloxane structure include those having a structure represented by the following formula (4).

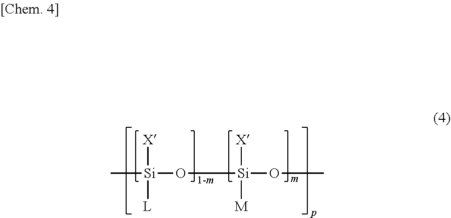

In the formula, m falls within the range of 0 to 1; p shows the degree of polymerization and is an integer of 1 or greater, preferably 10 or greater; X′ represents a hydrogen atom, a hydroxy group, a methyl group, an ethyl group, a methoxy group, or an ethoxy group; L represents a group represented by the following formula (5); and M represents another side chain, preferably, for example, a vertical alignment group.

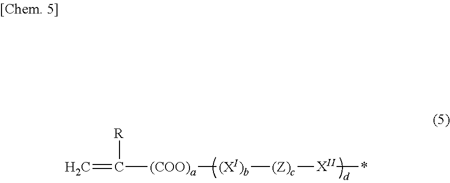

In the formula, R represents a hydrogen atom or a methyl group, X^{I} and X^{II} are the same as or different from each other, and each a 1,4-phenylene group, a methylene group, a 1,2-ethylene group, a 1,2-propylene group, or a 1,3-propylene group; and a, b, c, and d are the same as or different from each other, and each 0 or 1.

The preferred examples of the polymer whose main chain has a polysiloxane structure also include those having a polysiloxane structure represented by the following formula (6-1) or (6-2).

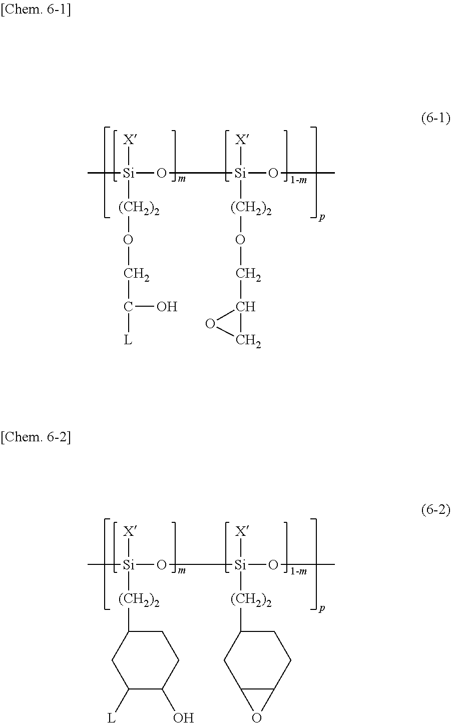

In the formulas (6-1) and (6-2), m falls within the range of 0 to 1; p shows the degree of polymerization and is an integer of 1 or greater, preferably 10 or greater; X′ represents a hydrogen atom, a hydroxy group, a methyl group, an ethyl group, a methoxy group, or an ethoxy group; and L represents a group represented by the following formula (7-1) or (7-2).

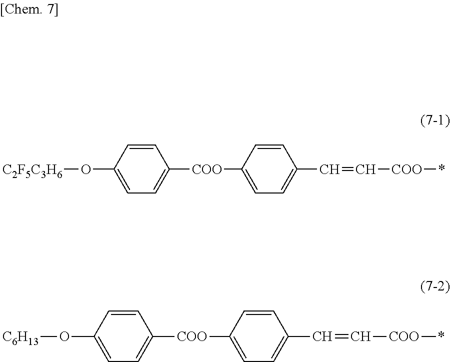

### (Example of Liquid Crystal Material (Alkenyl Group-Containing Liquid Crystal Compound))

The liquid crystal material preferably contains an alkenyl group-containing liquid crystal compound including one alkenyl group per molecule, more preferably, for example, at least one species of liquid crystal molecules represented by any one of the following formulas (8-1) to (8-4). An alkenyl group is, in other words, a vinyl group. The alkenyl group-containing liquid crystal compound can enhance the response performance of the liquid crystal display device, and such a liquid crystal display device becomes suitable for applications such as HMDs.

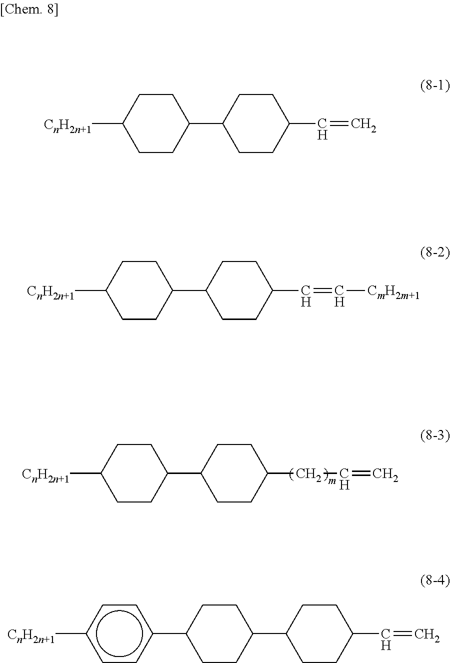

In the formulas, m and n are the same as or different from each other, and each an integer of 1 to 6; and m and n are each preferably, for example, an integer of 2 to 4.

Preferred specific examples of the liquid crystal molecules represented by the above formula (8-1) include those represented by the following formula (9).

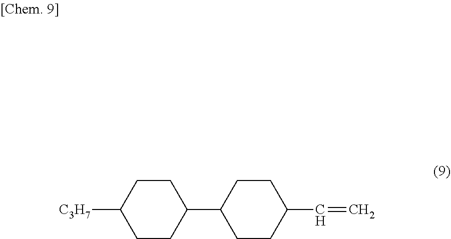

### (Example of Photo-Radical Polymerization Initiator in Alignment Film or Sealant)

A photo-radical polymerization initiator in the alignment film or the sealant is preferably, for example, a compound such as IRGACURE 651, IRGACURE 189, or IRGACURE-OXE01 (all from BASF) or a compound represented by the following formula (10-1) or (10-2).

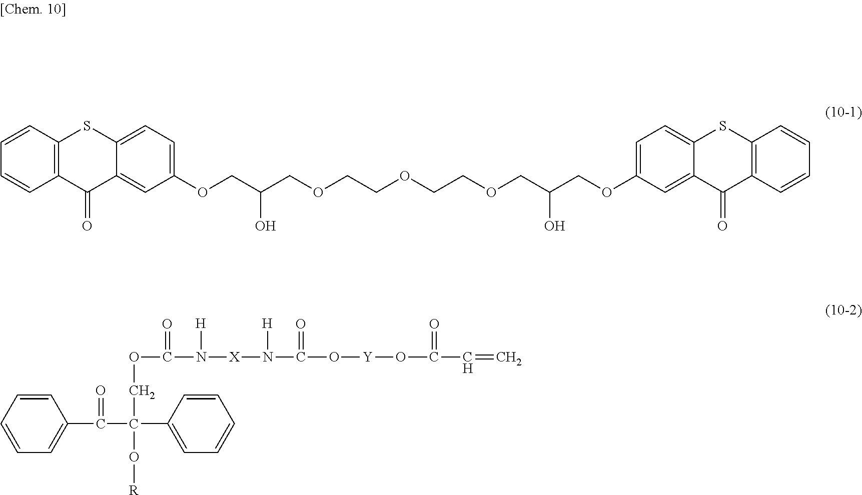

In the above formula (10-2), R represents a hydrogen atom or a C1-C4 aliphatic hydrocarbon group; X represents a C1-C13 group derived from a bifunctional isocyanate derivative; and Y represents a C1-C4 aliphatic hydrocarbon group or an aliphatic hydrocarbon group having an atomic ratio between carbon and oxygen of 3 or less.

### (Example of (Meth)Acrylic Monomer Constituting Sealant)

The sealant according to the present invention is preferably a curable resin composition containing a curable resin as a resin component. The curable resin may be any resin containing ultraviolet-reactive functional group and a heat-reactive functional group. Still, those having a (meth)acryloyl group and/or an epoxy group are suitable because the curing reaction of the curable resin composition proceeds smoothly when the composition is used as a sealant for the liquid crystal dropping technique and achieves favorable adhesion. Examples of such a curable resin include (meth)acrylates and epoxy resins. These resins may be used alone or in combination with each other. The (meth)acryl as used herein means acryl or methacryl.

Examples of the (meth)acrylates include urethane (meth)acrylates having a urethane bond and epoxy (meth)acrylates derived from a glycidyl group-containing compound and a (meth)acrylic acid.

Non-limiting specific examples of the urethane (meth)acrylates include derivatives from a diisocyanate such as isophorone diisocyanate and a reactive compound capable of undergoing addition reaction with an isocyanate, such as an acrylic acid or hydroxyethyl acrylate. These derivatives may be subjected to chain extension with caprolactone or a polyol, for example. Commercially available products of the urethane (meth)acrylates include U-122P, U-340P, U-4HA, and U-1084A (all from Shin-Nakamura Chemical Co., Ltd.); and KRM 7595, KRM 7610, and KRM 7619 (all from Daicel-UCB Co., Ltd.).

Non-limiting examples of the epoxy (meth)acrylates include epoxy (meth)acrylates derived from a (meth)acrylic acid and an epoxy resin such as a bisphenol A epoxy resin or propylene glycol diglycidyl ether. Commercially available products of the epoxy (meth)acrylates include EA-1020, EA-6320, and EA-5520 (all from Shin-Nakamura Chemical Co., Ltd.); and epoxy ester 70PA and epoxy ester 3002A (all from Kyoeisha Chemical Co., Ltd.).

The examples of the (meth)acrylates also include methyl methacrylate, tetrahydrofurfuryl methacrylate, benzyl methacrylate, isobornyl methacrylate, 2-hydroxyethyl methacrylate, glycidyl methacrylate, (poly)ethylene glycol dimethacrylate, 1,4-butanediol dimethacrylate, 1,6-hexanediol dimethacrylate, trimethylol propane triacrylate, pentaerythritol triacrylate, and glycerol dimethacrylate.

Examples of the epoxy resins include phenol novolac epoxy resins, cresol novolac epoxy resins, biphenyl novolac epoxy resins, trisphenol novolac epoxy resins, dicyclopentane novolac epoxy resins, bisphenol A epoxy resins, bisphenol F epoxy resins, 2,2′-diallyl bisphenol A epoxy resins, bisphenol S epoxy resins, hydrogenated bisphenol A epoxy resins, propylene oxide-added bisphenol A epoxy resins, biphenyl epoxy resins, naphthalene epoxy resins, resorcinol epoxy resins, and glycidyl amines.

Examples of commercially available products of the epoxy resins include the following. Examples of the biphenyl novolac epoxy resins include NC-3000S (Nippon Kayaku Co., Ltd.). Examples of the trisphenol novolac epoxy resins include EPPN-501H (Nippon Kayaku Co., Ltd.). Examples of the dicyclopentadiene novolac epoxy resins include NC-7000L (Nippon Kayaku Co., Ltd.). Examples of the bisphenol A epoxy resins include EPICLON 840-S and EPICLON 850-CRP (both from DIC Corporation). Examples of the bisphenol F epoxy resins include EPIKOTE 807 (Japan Epoxy Resins Co., Ltd.) and EPICLON 830 (DIC Corporation). Examples of the 2,2′-diallyl bisphenol A epoxy resins include RE310NM (Nippon Kayaku Co., Ltd.). Examples of the hydrogenated bisphenol A epoxy resins include EPICLON 7015 (DIC Corporation). Examples of the propylene oxide-added bisphenol A epoxy resins include epoxy ester 3002A (Kyoeisha Chemical Co., Ltd.). Examples of the biphenyl epoxy resins include EPIKOTE YX-4000H and YL-6121H (Japan Epoxy Resins Co., Ltd.). Examples of the naphthalene epoxy resins include EPICLON HP-4032 (DIC Corporation). Examples of the resorcinol epoxy resins include DENACOL EX-201 (Nagase ChemteX Corporation). Examples of the glycidyl amines include EPICLON 430 (DIC Corporation) and EPIKOTE 630 (Japan Epoxy Resins Co., Ltd.).

Suitable examples of the curable resin in the curable resin composition include epoxy/(meth)acrylic resins containing in one molecule at least one (meth)acrylic group and at least one epoxy group.

Examples of the epoxy/(meth)acrylic resins include resins obtained by reacting some epoxy groups of the epoxy resin with a (meth)acrylic acid in the presence of a basic catalyst by the usual procedure; resins obtained by reacting 1 mol of a bi- or higher functional isocyanate with ½ mol of a (meth)acrylic monomer containing a hydroxy group and then with ½ mol of glycidol; and resins obtained by reacting a (meth)acrylate having an isocyanate group with glycidol. Examples of commercially available products of the epoxy/(meth)acrylic resins include UVAC1561 (Daicel-UCB Co., Ltd.).

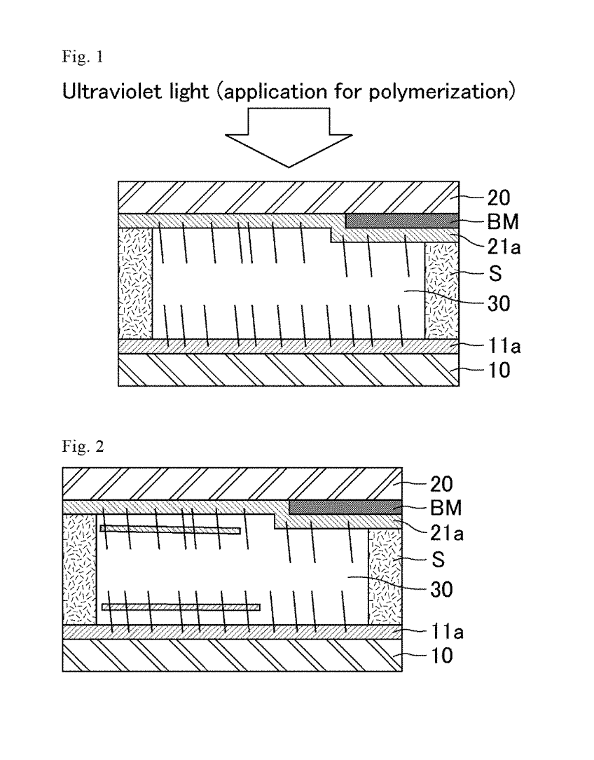

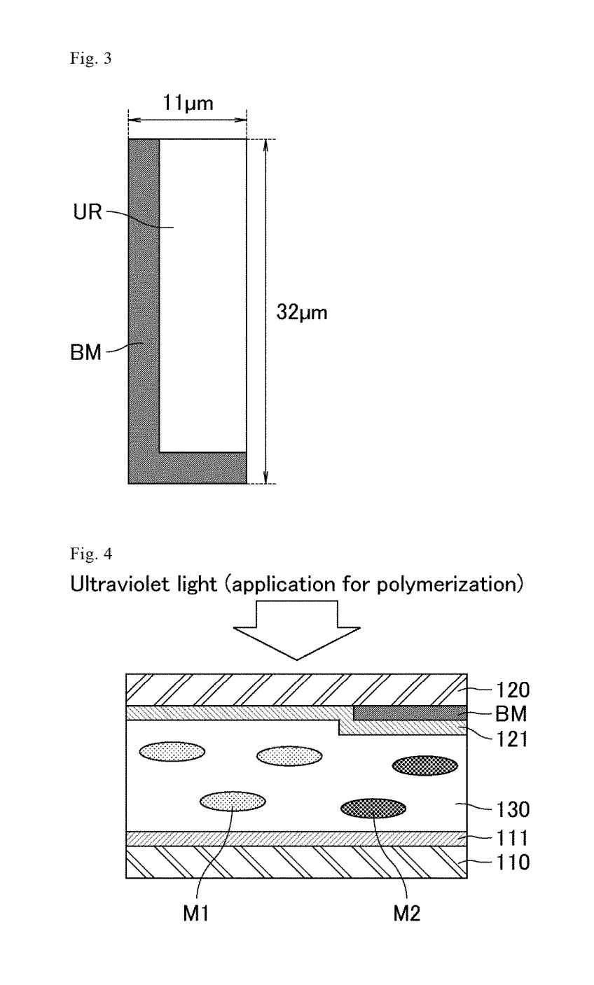

The method of producing the liquid crystal display device of the present embodiment is described below. FIG. 1 is a schematic cross-sectional view of a liquid crystal display device of the present embodiment. FIG. 2 is another schematic cross-sectional view of the liquid crystal display device of the present embodiment. FIG. 3 is a schematic top view of a liquid crystal display device for HMDs. FIG. 4 is a schematic cross-sectional view of a conventional liquid crystal display device. As shown in FIGS. 1 and 2, the liquid crystal display device of the present embodiment includes a CF substrate 10, a TFT substrate 20 including a light-shielding region BM, a liquid crystal layer 30 between the CF substrate 10 and the TFT substrate 20, a polymerizable group-containing alignment film 11a disposed on the liquid crystal layer 30 side surface of the CF substrate 10, a polymerizable group-containing alignment film 21a disposed on the liquid crystal layer 30 side surface of the TFT substrate 20, and a sealant S bonding the CF substrate 10 and the TFT substrate 20 to each other. As shown in FIG. 4, a conventional liquid crystal display device includes a CF substrate 110, a TFT substrate 120 including a light-shielding region BM, a liquid crystal layer 130 between the CF substrate 110 and the TFT substrate 120, an alignment film 111 disposed on the liquid crystal layer 130 side surface of the CF substrate 110, and an alignment film 121 disposed on the liquid crystal layer 30 side surface of the TFT substrate 20. The liquid crystal layer 130 is formed from a liquid crystal material containing a monomer. As shown in FIG. 4, the conventional PSA technique adds monomers to the liquid crystal material and polymerizes monomers M1 by ultraviolet irradiation. Here, in the case where the aperture ratio of the liquid crystal display device (the ratio of ultraviolet-irradiated region UR to the total of the light-shielding region BM and the ultraviolet-irradiated region UR) is low as shown in FIG. 3, monomers M2 are likely to remain in unirradiated regions even when the ultraviolet irradiation dose is increased. In the present embodiment, in order to prevent the monomers from spreading into the display region during use of the liquid crystal display device even when polymerization of the polymerizable groups does not proceed in the unirradiated regions, polymerizable groups (vinyl groups such as acrylic groups or methacrylic groups and/or cinnamate groups) are introduced into the polymer constituting the alignment films instead of utilizing monomers containing a polymerizable group in the liquid crystal layer (see FIG. 1). FIG. 1 shows a state where polymerizable groups are fixed by chemical bonds to side chains of a polymer constituting the polymerizable group-containing alignment films 11a and 21a. FIG. 2 shows the state where the application of ultraviolet rays shown in FIG. 1 caused the polymerizable groups chemically bonded to the side chains of the polymer constituting the alignment films to react and polymerize with each other. This seems to prevent unreacted monomers from spreading into the display region during use of the liquid crystal display device even when the polymerizable groups in the non-display region do not react (polymerize) when irradiated with ultraviolet rays, whereby image sticking due to residual monomers is avoided. The ultraviolet irradiation dose can be reduced also by using a liquid crystal material containing a compound vulnerable to ultraviolet rays and likely to cause image sticking due to a VHR decrease or rDC in the conventional PSA technique, such as an alkenyl group-containing liquid crystal compound. With a reduced ultraviolet irradiation dose, even when unpolymerized polymerizable groups or radical polymer terminals remain after application of ultraviolet rays for polymerization, the polymerizable groups, chemically bonded to the side chains of the polymer constituting the alignment films, and radicals do not spread in the liquid crystal. This can reduce image sticking due to a VHR decrease or rDC. Also, even when unpolymerized polymerizable groups remain, the image sticking can be reduced since the groups are prevented from spreading and thus the spreading and polymerization of the groups hardly proceed unlike the case of introducing monomers into the liquid crystal. The ultraviolet irradiation dose is, for example, preferably 0.5 to 5 J/cm², more preferably 1 to 4 J/cm², still more preferably 2 to 3 J/cm². In order to polymerize the polymerizable groups introduced into the side chains of the polymer constituting the alignment films, a photopolymerization initiator is required as shown in the following examples and comparative examples. The photopolymerization initiator may be introduced into the sealant or the alignment films.

Examples corresponding to the above embodiment are described below. In the formulas, p shows the degree of polymerization and is an integer of 1 or greater, preferably 10 or greater.

### Polyamic Acid, Photopolymerization Initiator in Sealant, and Alkenyl Group-Containing Liquid Crystal Compound

### Examples 1-1 to 1-3

### (Production of Liquid Crystal Cell)

A TFT substrate with a different pixel size (active matrix substrate with thin-film transistor (TFT) elements) and a counter substrate (for example, color filter (CF) substrate) including electrodes provided with slits were prepared. To each substrate was applied an alignment film material (vertical alignment film material) containing a polyamic acid having a structure including a methacrylic polymerizable group, which is represented by the following formula (1a). The material was pre-baked at 80° C. for two minutes and post-baked at 200° C. for 40 minutes, so that alignment films were formed. To one of the substrates was applied in a predetermined pattern a ultraviolet-curable, heat-curable sealant (the sealant contains any one of a photopolymerization initiator represented by the following formula (10-1), a photopolymerization initiator represented by the following formula (10-2), and IRGACURE-OXE01 (BASF), and contains at least a (meth)acrylic monomer, an epoxy monomer, and an epoxy curing agent) using a dispenser. Onto the predetermined position on the other substrate was dropped a negative liquid crystal material. The liquid crystal material contains a monofunctional alkenyl group-containing liquid crystal compound. The substrates were bonded to each other in vacuum, and the sealant was cured by ultraviolet rays (including ultraviolet rays having a wavelength of 300 to 400 nm). The substrates were further heated at 130° C. for 40 minutes for re-alignment treatment where the sealant was heat-cured and the liquid crystals were transformed into the isotropic phase. Ultraviolet rays at a dose of 2.5 J/cm² were applied to the resulting liquid crystal panel at room temperature while a voltage of 10 V was applied to the liquid crystal panel, so that the polymerizable groups in the polyamic acid side chains were polymerized. The liquid crystal panel was subjected to the PSA treatment, whereby a PSA-type liquid crystal display device was produced.

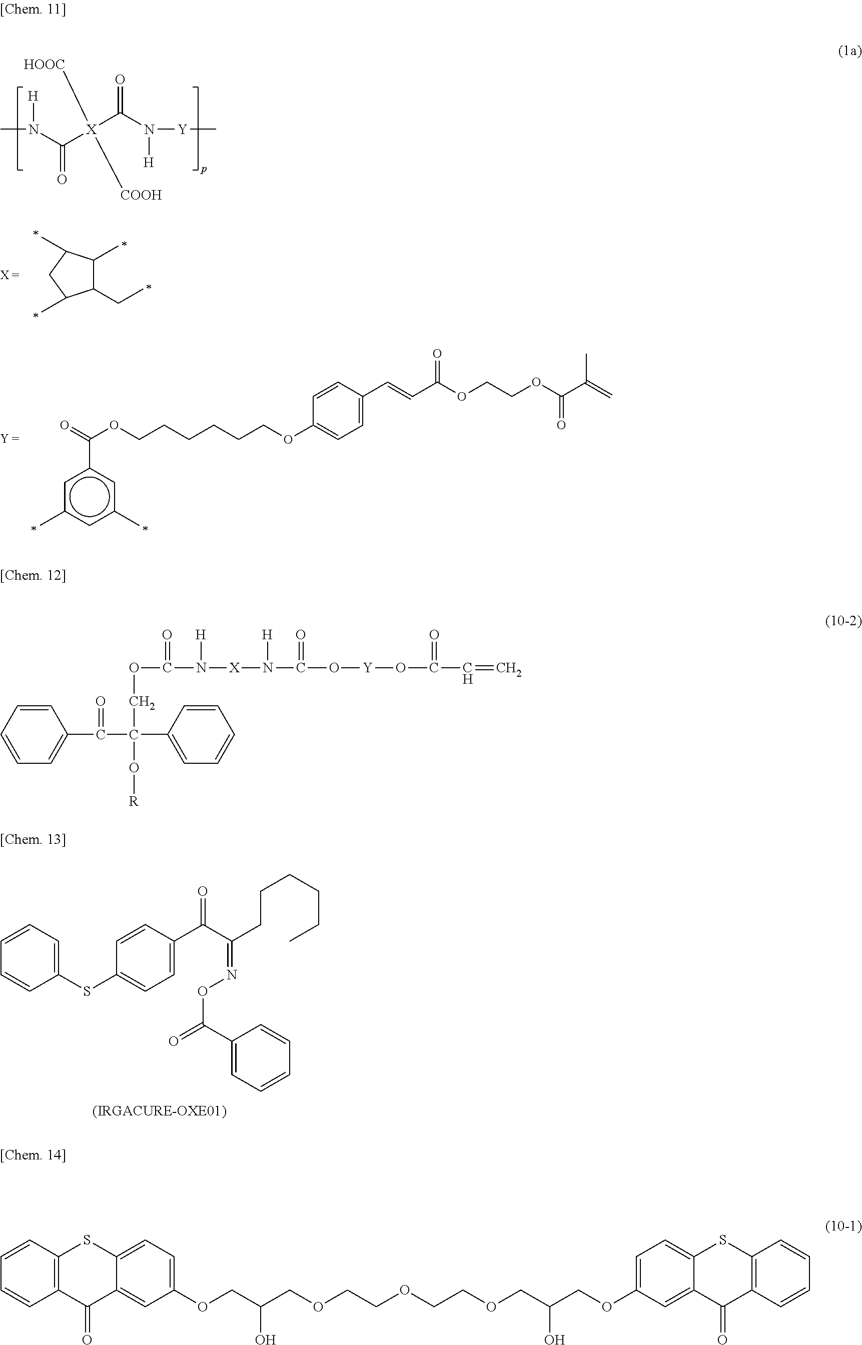

### (Pixel Size and Ultraviolet-Irradiated Area Ratio)

Width of gate lines and source lines (copper): 3 μm

Pixel size: 31.7 rpm×10.6 μm (irradiated area ratio: 64.9%)

### Comparative Example 1

A liquid crystal cell having the same structure as above was produced from the same material as above, except that a sealant containing an epoxy monomer and an epoxy curing agent but containing no photopolymerization initiator and no (meth)acrylic monomer was used.

### Evaluation Items in Examples 1-1 to 1-3 and Comparative Example 1

Pre-tilt angle: pre-tilt angle was measured by the crystal rotation method with OMS-AF2 from Chuo Precision Industrial Co., Ltd.

VHR: VHR was measured with a VHR measurement system Model 6254 from Toyo Corporation at 1 V and 70° C.

rDC: rDC after application of a DC offset voltage for two hours (h) was evaluated by the flicker elimination method (high-temperature test on backlight).

The liquid crystal cell was subjected to 100-hour aging under illumination of the LED backlight, with a voltage of 10 V applied. The results are shown in the following Table 1.

TABLE 1

| | | Initial (0 h) | | | 1000 h later | | |
|---|---|---|---|---|---|---|---|
| | Polymerization | Pre-tilt | VHR | rDC | Pre-tilt | VHR | rDC |
| | initiator in sealant | angle (°) | (%) | (mV) | angle (°) | (%) | (mV) |
| Example 1-1 | (10-2) | 87.5 | 98.6 | 20 | 86.8 | 98.1 | 30 |
| Example 1-2 | (IRGACURE- | 87.5 | 98.4 | 20 | 86.9 | 97.7 | 40 |
| | OXE01) | | | | | | |
| Example 1-3 | (10-1) | 87.8 | 98.9 | 10 | 87.0 | 98.3 | 30 |
| Comparative | — | 89.9 | 97.9 | — | 89.9 | 96.6 | — |
| Example 1 | | | | | | | |

Table 1 shows that in the examples, when polymerizable groups were chemically bonded to polyamic acid side chains and polymerized in the state where a photopolymerization initiator was introduced into the sealant, the pre-tilt angle was 87.5° to 87.8° (initial pre-tilt angle). In contrast, the pre-tilt angle in the state where no photopolymerization initiator was introduced into the sealant in the comparative example was substantially 90°, meaning that no tilt was provided. This is because application of ultraviolet rays did not cause polymerization of the alignment film side chains. In the state where a photopolymerization initiator was introduced into the sealant, however, application of ultraviolet rays from the outside of the liquid crystal display device seems to have generated radicals from the photopolymerization initiator in the sealant, polymerizing the polymerizable groups in the alignment film side chains. Here, the photopolymerization initiator used may be any one of cleavage-type ones (acetophenone-based one represented by the formula (10-2), oxenyl (oxime ester)-based one such as IRGACURE-OXE01) and hydrogen abstraction-type ones (thioxanthone-based one represented by the formula (10-1)). In the examples, the initial VHR and the VHR after 1000-hour (h) aging were both as high as 98% or greater, and the rDC was as low as 30 mV or lower. In Comparative Example 1, the attempt to control the alignment by tilt angle provision was unsuccessful, and thus the rDC was not measured by the flicker elimination method. These results show that introducing a photopolymerization initiator into the sealant enables polymerization of polymerizable groups in the side chains of the polymer constituting the alignment films and achieves a high VHR and a low rDC even when the liquid crystal material contains an alkenyl group-containing liquid crystal compound. The results also show that the liquid crystal display devices of the examples can cause liquid crystal molecules in a voltage applied state to respond at a high speed, thereby achieving more rapid response. This is because the liquid crystal material contains the alkenyl group-containing liquid crystal compound and the pre-tilt angle is slightly smaller than 900, i.e., the initial alignment azimuth of the liquid crystal molecules is inclined from the vertical direction (the tilt is provided).

### Examples 2-1 to 2-3

### (Production of Liquid Crystal Cell)

A liquid crystal cell was produced by the same method as in Examples 1-1 to 1-3 using the same alignment film material, liquid crystal material, and sealant material as in Examples 1-1 to 1-3, except that the pixel size was changed to 28.2 μm×9.4 μm (irradiated area ratio: 60.8%).

### Comparative Example 2

A liquid crystal cell was produced by the same processes as in Example 2-2 using the same sealant material as in Example 2-2, except that a polymer containing no polymerizable group was used as the vertical alignment film material (polymer represented by the following formula (1b)) and a liquid crystal material containing 0.3% by mass of a bifunctional monomer (dimethacryloyloxy biphenyl represented by the following formula (A)) was used as the negative liquid crystal material. Comparative Example 2 is a comparative example since the alignment film material contains no polymerizable group.

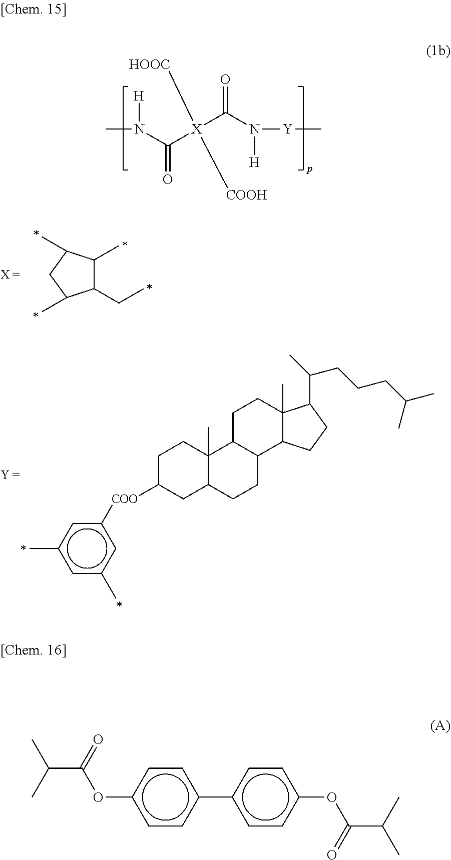

### (Evaluation Items)

Pre-tilt angle: pre-tilt angle was measured by the crystal rotation method with OMS-AF2 from Chuo Precision Industrial Co., Ltd.

AC image sticking: the image sticking ratio (ISR) was evaluated before and after the following aging in accordance with the evaluation method disclosed in JP 2003-307720 A.

VHR: VHR was measured with a VHR measurement system Model 6254 from Toyo Corporation at 1 V and 70° C. rDC: rDC after application of a DC offset voltage for two hours (h) was evaluated by the flicker elimination method (high-temperature test on backlight).

The aging was performed as in Examples 1-1 to 1-3. The results are shown in the following Table 2.

TABLE 2

| | | Initial (0 h) | | | | 1000 h later | | | |
|---|---|---|---|---|---|---|---|---|---|
| | Polymerization | Pre-tilt | ISR | VHR | rDC | Pre-tilt | ISR | VHR | rDC |
| | initiator in sealant | angle (°) | (%) | (%) | (mV) | angle (°) | (%) | (%) | (mV) |
| Example 2-1 | (10-2) | 87.6 | 2 | 98.3 | 20 | 86.8 | 8 | 97.8 | 30 |
| Example 2-2 | (IRGACURE- | 87.5 | 2 | 98.1 | 20 | 86.8 | 9 | 97.5 | 40 |
| | OXE01) | | | | | | | | |
| Example 2-3 | (10-1) | 87.7 | 2 | 98.3 | 10 | 87.0 | 8 | 97.8 | 30 |
| Comparative | (IRGACURE- | 88.9 | 8 | 94.4 | 60 | 84.4 | 36 | 92.3 | 190 |
| Example 2 | OXE01) | | | | | | | | |

Table 2 shows that in the examples, when polymerizable groups were added to polyamic acid side chains and polymerized in the state where a photopolymerization initiator was introduced into the sealant, the pre-tilt angle was 87.5° to 87.7° (in the initial stage) and then 86.8° to 87.0° (after the aging). These pre-tilt angles provided were appropriate and the tilt angle variation caused by the aging was relatively small. Also in the examples, since the liquid crystal material contained an alkenyl group-containing liquid crystal compound and the pre-tilt angle was provided, rapid response was achieved as described above. In contrast, when a polymerizable bifunctional monomer was introduced into the liquid crystal material and polymerized by ultraviolet rays in Comparative Example 2, the initial pre-tilt angle was as large as 88.9°, and the pre-tilt angle after the 1000-h aging was as small as about 840. In the case where a polymerizable bifunctional monomer was introduced into the liquid crystal material containing an alkenyl group-containing liquid crystal compound and polymerized, the polymerization by ultraviolet rays was less likely to proceed, and thus the initial tilt angle was large. The pre-tilt angle then dropped to about 84° presumably because the monomer remained in the liquid crystal material after the application of ultraviolet rays and the residual monomer was polymerized during the 1000-h aging.

In the comparative example, monomers having radicals are presumed to remain in the liquid crystal material, which caused undesirable results, namely a more significant VHR decrease than in the examples and a higher rDC than in the examples (both in the initial stage and 1000 h later).

### Polyamic Acid, Photopolymerization Initiator in Alignment Film, and Alkenyl Group-Containing Liquid Crystal Compound

### Examples 3-1 to 3-3

### (Production of Liquid Crystal Cell)

A TFT substrate with a different pixel size and a counter substrate with slit electrodes were prepared. To each substrate were applied an alignment agent (vertical alignment agent) containing a polyamic acid having a methacrylic polymerizable group, which is represented by the following formula (1c), and an alignment agent containing 3% by mass of any one of IRGACURE 651, IRGACURE-OXE01 (photopolymerization initiators from BASF), and a photopolymerization initiator represented by the following formula (a) relative to the solute of the alignment agent. The alignment agents were pre-baked at 80° C. for two minutes and then post-baked at 200° C. for 40 minutes, so that alignment films were formed. To one of the substrates was applied in a predetermined pattern a heat-curable sealant (Model) using a dispenser. Onto the predetermined position on the other substrate was dropped a negative liquid crystal material. The liquid crystal material contains an alkenyl group-containing liquid crystal compound. The substrates were bonded to each other in vacuum, and the sealant was cured by ultraviolet rays (including ultraviolet rays having a wavelength of 300 to 400 nm). The substrates were further heated at 130° C. for 40 minutes for re-alignment treatment where the sealant was heat-cured and the liquid crystals were transformed into the isotropic phase. Ultraviolet rays at a dose of 2.5 J/cm² were applied to the resulting liquid crystal panel at room temperature while a voltage of 10 V was applied to the liquid crystal panel, so that the polymerizable groups in the polyamic acid side chains were polymerized. The liquid crystal panel was subjected to the PSA treatment, whereby a PSA-type liquid crystal display device was produced.

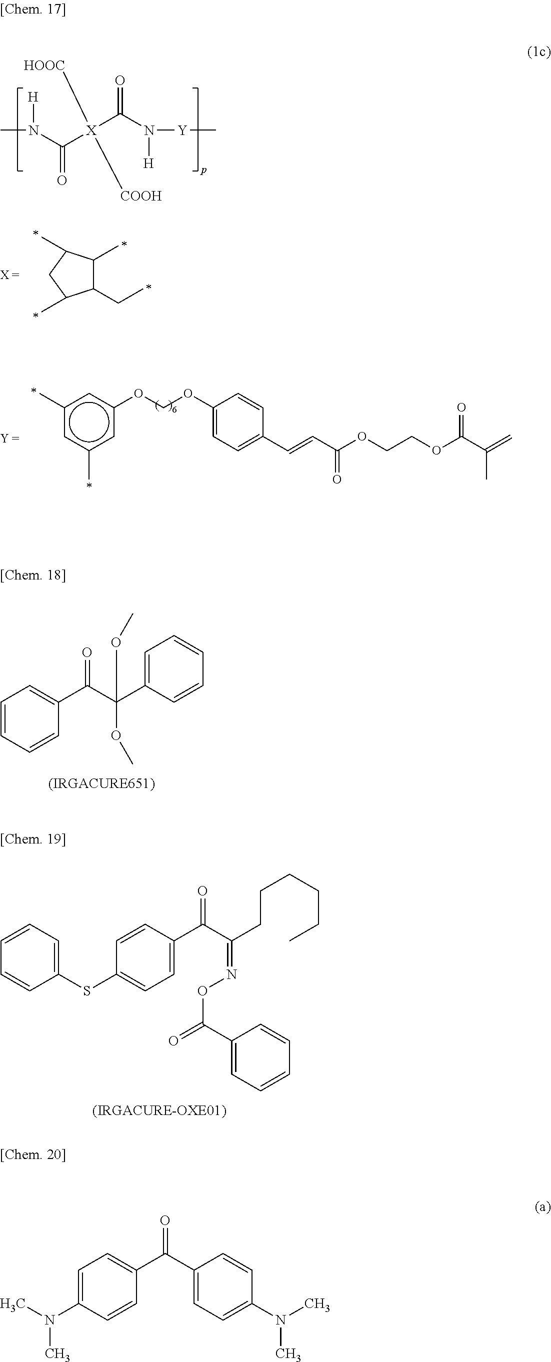

### (Pixel Size and Ultraviolet-Irradiated Area Ratio)

Width of gate lines and source lines (aluminum): 4 μm

Pixel size: 25.4 μm×8.5 μm (irradiated area ratio: 57.1%)

### Comparative Example 3

A liquid crystal cell was produced as in Examples 3-1 to 3-3, except that alignment films containing no photopolymerization initiator were used as the alignment films.

### (Evaluation Items)

The same evaluation items as in Examples 2-1 to 2-3 were employed.

### (High-Temperature Test on Backlight)

The same test as in Examples 1-1 to 1-3 was conducted.

The results are shown in the following Table 3.

TABLE 3

| | Polymerization | Initial (0 h) | | | | 1000 h later | | | |
|---|---|---|---|---|---|---|---|---|---|
| | initiator in alignment | Pre-tilt | ISR | VHR | rDC | Pre-tilt | ISR | VHR | rDC |
| | film | angle (°) | (%) | (%) | (mV) | angle (°) | (%) | (%) | (mV) |
| Example 3-1 | (IRGACURE 651) | 87.5 | 2 | 98.5 | 30 | 86.9 | 10 | 97.5 | 60 |
| Example 3-2 | (IRGACURE- | 87.6 | 2 | 98.2 | 30 | 87.1 | 12 | 97.1 | 90 |
| | OXE01) | | | | | | | | |
| Example 3-3 | (a) | 88.3 | 2 | 97.7 | 50 | 87.4 | 9 | 96.0 | 100 |
| Comparative | — | 90.0 | — | 94.1 | — | 90.0 | — | 91.3 | — |
| Example 3 | | | | | | | | | |

Table 3 shows that in the examples, when IRGACURE 651, IRGACURE-OXE01 (both are cleavage-type initiators), or the photopolymerization initiator (hydrogen abstraction-type initiator) represented by the formula (a) was introduced into the alignment films, the polymerizable groups in the side chains of the polymer constituting the alignment films were polymerized when irradiated with ultraviolet rays, a pre-tilt angle of about 87° to 88° was provided, and low image sticking, a high VHR, and a low rDC were achieved. The liquid crystal display devices in the examples utilize a liquid crystal material containing an alkenyl group-containing liquid crystal compound and successfully provide a pre-tilt angle, and thereby can achieve rapid response as described above. In contrast, when no polymerization initiator is introduced into any of the alignment films and the sealant in Comparative Example 3, the polymerizable groups in the side chains of the polymer constituting the alignment films were not polymerized when irradiated with ultraviolet rays, and a pre-tilt angle of about 87° was not provided.

These results show that the polymerizable groups in the side chains of the polymer constituting the alignment films can be polymerized also by introducing a photopolymerization initiator into the alignment films.

### Polysiloxane

### Example 4

### (Production of Liquid Crystal Cell)

A liquid crystal cell was produced under the same conditions as in Example 1, except that an alignment agent (vertical alignment agent) containing a vertical alignment polysiloxane with a cinnamate group, which is represented by the following formula (6-2), was used.

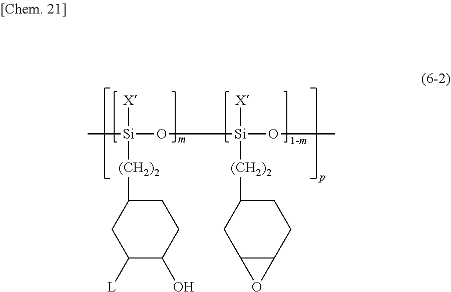

In the formula, X′ represents a methoxy group; m is 0.5; and L represents a group represented by the following formula (7-1), a group represented by the following formula (7-2), or a mixture of these groups.

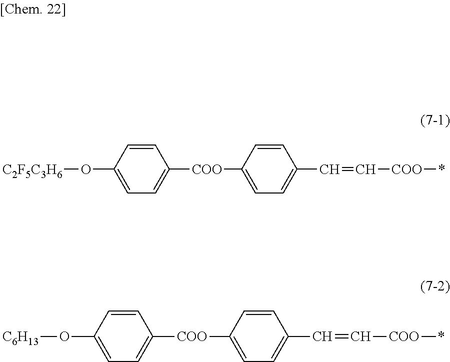

### (Pixel Size and Ultraviolet-Irradiated Area Ratio)

Width of gate lines and source lines (copper): 3 μm

Pixel size: 31.7 μm×10.6 μm (irradiated area ratio: 64.9%)

### (Evaluation Items)

The same evaluation items as in Examples 2-1 to 2-3 were employed.

### (High-Temperature Test on Backlight)

The same test as in Examples 1-1 to 1-3 was conducted.

The results are shown in the following Table 4.

TABLE 4

| | Initial (0 h) | | | | 1000 h later | | | |
|---|---|---|---|---|---|---|---|---|
| | Pre-tilt | ISR | VHR | rDC | Pre-tilt | ISR | VHR | rDC |
| | angle (°) | (%) | (%) | (mV) | angle (°) | (%) | (%) | (mV) |
| Example 4 | 87.9 | 1 | 99.1 | 0 | 87.0 | 4 | 98.3 | 10 |

Table 4 shows that when a polysiloxane containing a cinnamate group in a side chain was used, a pre-tilt angle of 87° was provided, a high VHR of 98% or higher and a low rDC of 10 mV were achieved even after the 1000-h aging, and the image sticking ratio was low, as in Example 1. Also, since the liquid crystal material contains an alkenyl group-containing liquid crystal compound and a pre-tilt angle is provided, rapid response can be achieved as described above.

The present invention is also applicable to ECB mode, TN mode, and vertical TN (VATN) mode liquid crystal display devices.

The liquid crystal display device of the present invention is preferably in a display mode of the twisted nematic (TN) mode, the electrically controlled birefringence (ECB) mode, the IPS mode, the FFS mode, the VA mode, or the VATN mode. The liquid crystal display device of the present invention may also be a transmissive liquid crystal display device, a reflective liquid crystal display device, or a transflective liquid crystal display device. In the case where the liquid crystal display device of the present invention is a transmissive liquid crystal display device or a transflective liquid crystal display device, the liquid crystal display device of the present invention typically includes a backlight.

### [Additional Remarks]

One aspect of the present invention may be a method of producing a liquid crystal display device including the pair of substrates 10 and 20 and the liquid crystal layer 30 disposed between the substrates 10 and 20, the method including: forming the liquid crystal layer 30 by sealing a liquid crystal material containing liquid crystal molecules including an alkenyl group between the substrates 10 and 20 facing each other with the sealant S in between; and performing an alignment treatment on the alignment films 11a and 21a containing a polymer including a polymerizable group in a side chain and being disposed on the liquid crystal layer 30 side surface of at least one of the substrates 10 and 20 by irradiating the alignment films 11a and 12a with ultraviolet rays and thereby polymerizing the polymerizable group. This aspect of the present invention, utilizing the liquid crystal layer 30 containing liquid crystal molecules including an alkenyl group, can increase the response speed of liquid crystal molecules in a voltage applied state, achieving rapid response. Also, the polymer constituting the alignment films 11a and 21a contains polymerizable groups in its side chains. These polymerizable groups, even when they remain unpolymerized after being irradiated with ultraviolet rays for polymerization, do not (or less likely to) spread into the liquid crystal layer 30 since they are introduced into the side chains of the polymer. This enables reduction of the ultraviolet irradiation dose while reducing image sticking due to a VHR decrease and/or rDC. Such a liquid crystal display device can therefore use a compound easily cleaving under ultraviolet rays or easily generating radicals due to cleavage, such as the liquid crystal molecules including an alkenyl group, as the liquid crystal material.

The alignment treatment may be performed to align the liquid crystal molecules in the direction perpendicular to the alignment films 11a and 21a.

The performing an alignment treatment may include irradiating a radical polymerization initiator in the alignment films 11a and 21a with ultraviolet rays to generate a radical and thereby polymerizing the polymerizable group in the side chain of the polymer.

The performing the alignment treatment may include irradiating a radical polymerization initiator in the sealant S with ultraviolet rays to generate a radical and thereby polymerizing the polymerizable group in the side chain of the polymer.

The performing the alignment treatment may include irradiating the radical polymerization initiator with ultraviolet rays to cleave the radical polymerization initiator and generate a radical.

The performing the alignment treatment may include irradiating the radical polymerization initiator with ultraviolet rays to abstract a hydrogen atom from the radical polymerization initiator and generate a radical.

The polymerizable group may contain a vinyl group and/or a cinnamate group.

The forming the liquid crystal layer includes sealing a liquid crystal material containing liquid crystal molecules each including one alkenyl group between the substrates 10 and 20.

Another aspect of the present invention may be an alignment film including: a polymer material whose main chain is derived from a polyamic acid or a polysiloxane and whose side chain includes a vinyl group and/or a cinnamate group; and a radical polymerization initiator. The vinyl group and/or cinnamate group in this aspect, even when they remain unpolymerized after being irradiated with ultraviolet rays for polymerization, do not (or less likely to) spread into the liquid crystal layer 30 since they are introduced into the side chains of the polymer. This enables reduction of the ultraviolet irradiation dose while reducing image sticking due to a VHR decrease and/or rDC. Such a liquid crystal display device can therefore use a compound easily cleaving under ultraviolet rays or easily generating radicals due to cleavage, such as the liquid crystal molecules including an alkenyl group, as the liquid crystal material.

The radical polymerization initiator may generate a radical in a cleavage reaction or a hydrogen atom abstraction reaction.

### REFERENCE SIGNS LIST

10, 110: CF substrate
11a, 21a: polymerizable group-containing alignment film
20, 120: TFT substrate
30: liquid crystal layer
111, 121: alignment film
BM: light-shielding region
UR: ultraviolet-irradiated region
M1: monomer to be irradiated with ultraviolet rays and
polymerized
M2: monomer to be unirradiated with ultraviolet rays and
unpolymerized
S: sealant

1. A method of producing a liquid crystal display device including a pair of substrates and a liquid crystal layer disposed between the substrates, the method comprising:
forming the liquid crystal layer by sealing a liquid crystal material containing liquid crystal molecules including an alkenyl group between the substrates facing each other with a sealant in between; and
performing an alignment treatment on an alignment film containing a polymer including a polymerizable group in a side chain and being disposed on a liquid crystal layer side surface of at least one of the substrates by irradiating the alignment film with ultraviolet rays and thereby polymerizing the polymerizable group.

2. The method of producing a liquid crystal display device according to claim 1,
wherein the alignment treatment is performed to align the liquid crystal molecules in a direction perpendicular to the alignment film.

3. The method of producing a liquid crystal display device according to claim 1,
wherein the performing an alignment treatment includes irradiating a radical polymerization initiator in the alignment film with ultraviolet rays to generate a radical and thereby polymerizing the polymerizable group in the side chain of the polymer.

4. The method of producing a liquid crystal display device according to claim 1,
wherein the performing the alignment treatment includes irradiating a radical polymerization initiator in the sealant with ultraviolet rays to generate a radical and thereby polymerizing the polymerizable group in the side chain of the polymer.

5. The method of producing a liquid crystal display device according to claim 3,
wherein the performing the alignment treatment includes irradiating the radical polymerization initiator with ultraviolet rays to cleave the radical polymerization initiator and generate a radical.

6. The method of producing a liquid crystal display device according to claim 3,
wherein the performing the alignment treatment includes irradiating the radical polymerization initiator with ultraviolet rays to abstract a hydrogen atom from the radical polymerization initiator and generate a radical.

7. The method of producing a liquid crystal display device according to claim 1,
wherein the polymerizable group contains a vinyl group and/or a cinnamate group.

8. The method of producing a liquid crystal display device according to claim 1,
wherein the forming the liquid crystal layer includes sealing a liquid crystal material containing liquid crystal molecules each including one alkenyl group between the substrates.

9. An alignment film material comprising:
a polymer material whose main chain is derived from a polyamic acid or a polysiloxane and whose side chain includes a vinyl group and/or a cinnamate group; and
a radical polymerization initiator.

10. The alignment film material according to claim 9,
wherein the radical polymerization initiator generates a radical in a cleavage reaction or a hydrogen atom abstraction reaction.
